(19) United States
(12) Patent Application Publication
(10) Pub. No.: US 2011/0273364 A1
(43) Pub. Date: Nov. 10, 2011

(54) DEVICE FOR PORTABLE VIEWABLE REFLECTIVE DISPLAY SYSTEM

(75) Inventor: Olav Christensen, Brooklyn, NY (US)

(73) Assignee: 360BRANDVISION LLC, Las Vegas, NV (US)

(21) Appl. No.: 13/102,287

(22) Filed: May 6, 2011

Related U.S. Application Data
(60) Provisional application No. 61/332,026, filed on May 6, 2010.

(51) Int. Cl. G09G 5/00

(52) U.S. Cl. 345/7

(57) ABSTRACT

The invention relates to a mobile visual display device that includes a horizontal panel configured for displaying an illuminated reference image on a display screen, and a reflective or partially reflective surface coupled to a side of said panel and disposed over said display screen at an angle sufficient for receiving and reflecting at least a portion of the illuminated reference image to produce a reflected image.

### REFERENCE TO RELATED APPLICATIONS

This application claims priority to U.S. Provisional Application No. 61/332,026, filed May 6, 2010, the contents of which are incorporated by reference herein in its entirety.

### TECHNICAL FIELD

The present invention is directed to display systems, and more specifically, to interactive, portable display systems suitable for use in retail environments.

### BACKGROUND OF THE INVENTION

Within many disparate scenarios, there is a need for displaying images in such a manner that the object or image to be displayed appears as physical as possible. Several visual systems have been developed to give viewers a three-dimensional (3D) perception of two-dimensional images. For example, U.S. Pat. No. 6,356,397 discloses a pyramid formed by triangular mirrors for use in a panoramic viewing system. Here cameras monitor each mirror so that a panoramic view is obtained. An image processing device such as a projector can be used instead of the cameras. Likewise, U.S. Publication No. 20080144175 discloses a pyramid-like display device that enhances spatial aspects of three-dimensional objects recorded and displayed on two-dimensional surfaces part and display means. The pyramid-like part has semi-transparent, partly reflective facets. Projected images are reflected on the facets of the pyramid-like part.

However, a majority of the visual systems of the prior art are single purpose, non-portable, non-configurable systems that require low ambient lighting to operate sufficiently. They are not self contained and take much manpower to deploy and pack away. The systems are not self supported and do not allow for front projection. These rear projection systems use are designed for 10-12 k projection light units and are not able to handle high ambient lighting environments, such as in commercial and retail settings.

### SUMMARY OF THE INVENTION

The present disclosure includes a portable visual display system and method of displaying bright moving imagery in an indoor high ambient lighting environment such as in a retail environment, while an image is displaced optically and appears as a hologram.

More specifically, the visual display system of the invention includes a horizontal panel having a top surface and a bottom surface and a display screen disposed on the top surface. The panel is configured for displaying an illuminated reference image on the display screen. The visual display system further includes a reflective or partially reflective surface having at least two sides (e.g., a front and a back side) that is removably coupled to a side of the horizontal panel and disposed over the display screen at an angle sufficient for receiving and reflecting at least a portion of the illuminated reference image to produce a reflected image.

In a particular embodiment, the reflective or partially reflective surface is disposed at a 45 degree angle relative to said display screen. The reflected image is perceivable to a viewer at an angle ranging between 110 to 170 degrees, preferably 115 to 160 degrees, even more preferably 120 to 150 degrees relative to a center point of the reflective or partially reflective surface, or any specific value between said ranges.

The display screen of the panel has a brightness that is particularly suitable for high ambient lighting environments, such as in retail settings. In a particular embodiment, the brightness of the display screen ranges from 500 to 1,000 nits, or any specific value within this range. For example, the panel can be an LCD panel or LED panel having a brightness ranging from 500 to 1,000 nits.

The reflective or partially reflective surface can contain an anti-reflective coating on one side of the reflective or partially reflective surface. However, in some embodiments, an anti-reflective coating is not used. In a particular embodiment, the reflective or partially reflective surface is a beam splitter device. Examples of beam splitter devices include, without limitation, dielectric mirrors, dichroic mirrors, interferometers, teleprompter mirrors, half-silvered mirrors, or beam splitter cubes.

The visual display system is operable coupled to a player unit for displaying an image (e.g., still or moving images) on the display screen of the visual display system. In some embodiments, the player unit is an integrated component in the panel of the visual display system. The player unit can be any IP addressable or Wi-Fi capable unit, and is preferably contains a high definition (HD), video graphics array (VGA) or digital visual interference (DVI) output.

The visual display systems of the invention can further include a protective case for transporting said visual display system. The protective case includes a base unit having an interior cavity that is configured for securely housing at least the panel. For example, the base unit may contain a mount for mounting the panel of the visual display system, or one or more straps for securing the panel within the interior cavity of the base unit. The protective case further includes a detachable lid which can be removed and placed underneath the base unit as a stand. In certain embodiments, the detachable lid includes an internal sleeve for housing the reflective or partially reflective surface during transport.

### BRIEF DESCRIPTION OF THE DRAWINGS

In the drawings, like structures are referred to by like numerals throughout the several views. Note that the illustrations in the figures are representative only, and are not drawn to scale, the emphasis having instead been generally placed upon illustrating the principles of the invention and the disclosed embodiments. In the following description, various embodiments of the present invention are described with reference to the following drawings.

FIG. 1 depicts a side view of an exemplary embodiment of a visual display device according to the invention.

FIG. 2 depicts an example of an image shown on a display panel being reflected off of a display surface in an exemplary embodiment of a visual display device according to the invention.

FIG. 3 depicts an exemplary embodiment of a case unit housing a visual display device according to the invention

FIG. 4 depicts an exemplary embodiment of a visual display device mounted within a portable case unit.

### DETAILED DESCRIPTION

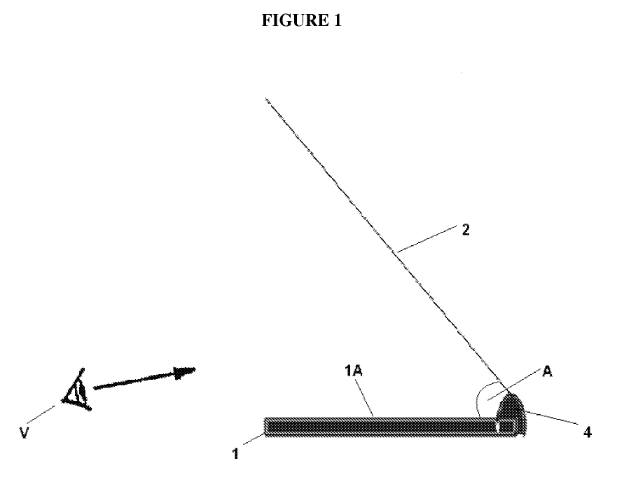

The present invention provides a compact, portable visual display system and method of displaying bright moving imagery in an indoor high ambient lighting environment such as in a retail environment, while an image is displaced optically and appears as a hologram. Referring now to FIG. 1, the device includes, among other things, a display panel 1 and a reflective or partially reflective display surface 2.

The display panel is a planar display surface having a screen 1a for displaying an intended image(s) (including motion picture or video images). This is in contrast to a projector, which may emit the intended picture information, but also requires an image-forming surface to make the picture information directly accessible to a viewer. For example, without limitation, the display panel is a liquid crystal display (LCD) panel or light-emitting diode (LED) panel. Where an LED panel is used, the LED panel is a conventional LED panel (e.g., using discrete LEDs) or a surface mounted device. Where an LCD panel is used, the LCD panel is a twisted nematic (TN) panel, a vertical alignment (VA) panel, or an in-plane switching (IPS) panel.

The display panel 1 has brightness sufficient for indoor use, such as in corporate, commercial and/or retail settings. For example, without limitation, a sufficient brightness for indoor use ranges from 500-1500 candelas per square meter (cd/m², also referred to herein as nits), preferably 500 to 1,000 nits, more preferably 500 to 800 nits, even more preferably 600 to 700 nits.

Preferably, the display panel 1 has a square or rectangular format, however, any shape (e.g., circular, oval, triangular, etc.) is suitable for use in the display system of the invention. The displayable area (i.e., from the lower corner to the opposite upper corner of the display, commonly referred to as the diagonal) of screen 1a display panel 1 can be any size. For example, the screen 1a of the display panel 1 is a 15 inch, 17 inch, 19 inch, 21.5 inch, 22 inch, 24 inch, 26 inch, 30 inch, 32 inch, 35 inch, 37 inch, 40 inch, 42 inch, 43 inch, 46 inch, 50 inch, 51 inch, 52 inch, 55 inch, 58 inch, 60 inch, 62 inch, 63 inch, 65 inch, screen, or greater.

The display panel 1 can have any aspect ratio, such as a traditional 4:3 aspect ratio, a 5:4 aspect ratio, or a widescreen 16:10 or 16:9 aspect ratio. In some embodiments, the display panel 1 has a 2:1 aspect ratio.

In certain embodiments, the screen 1a of display panel 1 has a resolution of 720p (1280×720 progressive scan), 1080i (1920×1080 split into two interlaced fields of 540 lines), or 1080p (1920×1080 progressive scan). In other embodiments, the screen 1a of display panel 1 has a resolution of 1400×1050 SXGA+, 1280×720 WXGA, 1280×800 (WXGA), 1440×900 (WXGA+), 1600×900 (WSXGA+), 1600×768(750) UWXGA, 1680×1050 WSXGA+, 1920×1080 (WUXGA), 1920×1200 WUXGA, 2560×1440 (WQHD) or 2560×1600. In still other embodiments, the screen 1a of display panel 1 has a resolution of 2560×1600 WQXGA. In yet other embodiments, the screen 1a of display panel 1 has a resolution of 3280×2048 WQSXGA

The display panel 1 further includes at least one analog (e.g., VGA or DSUB-15) and/or digital (e.g., HDMI or DVI) connector/input 3. The display panel 1 further includes a connector/input for a power source. For example, the display unit may include a dual PSU setup. The display panel 1 may also be configured for battery operation as a primary power or back-up power source.

A player unit 6, such as an HD (high definition), VGA (video graphics array) or DVI (digital visual interference) output, IP addressable or Wi-Fi capable (e.g., player unit can be connected to the display panel 1 via a connector/input 3. Alternatively, a player unit 6, such as an HD, VGA or DVI output, IP addressable or Wi-Fi capable player unit 6, is integrated into the display panel 1.

The display surface 2 is a reflective, or partially reflective, translucent surface having at least two sides that is approximately ¼ to ¾ of an inch thick, or approximately 4 to 10 mm (e.g., ¼ thick or approximately 5-6 mm). In certain embodiments, the display surface is a beam splitter device. As used herein, a beam splitter device refers to an optical device used to split incident light entering it by allowing approximately half of the light to transmit and continue along the originating path while reflecting the remaining light along a separate path. In this way the beam splitter provides two identical beams or images at about half the strength of the incident light. Examples of beam splitter devices include, without limitation, dielectric mirrors, dichroic mirrors, interferometers, teleprompter mirrors, half-silvered mirrors, and beam splitter cubes.

Preferably, the display surface contains an anti-reflective coating on one side to reduce reflection while increasing reflection on the other side in order to minimize ghosting. Ghosting occurs in a beam splitter when a small percentage of the incident light reflects off the secondary surface of the beam splitter instead of being transmitted out of the beam splitter. As the incident light approaches a 45 degree 50/50 beam splitter half of the light will reflect and half will transmit as intended. Once the transmitted light enters the beam splitter, it transmits most of that light out of the other side of the beam splitter along the intended path but also reflects a small portion of that light. This causes a dim ghost image to accompany the initial reflected light. Anti Reflection coatings reduce the amount of light that is unintentionally reflected by the coated surface. In this particular situation, the secondary surface of the beam splitter is coated with an anti-reflection coating in order to drastically reduce the amount of light that is being reflected by that surface. This helps to promote the integrity of the two divergent images. In certain embodiments, the display surface does not contain an anti-reflective coating. The display surface is completely translucent from both the front and back regardless of whether an anti-reflective coating is used.

In one embodiment, the display surface 2 is pivotably coupled to one side of the display panel 1 by a hinge or hinge-like connection 4 such that the display surface can be pivoted between a closed position and an open position, the closed position being substantially parallel to the display panel 1, and the open position being raised up to a 90 degree angle relative to the display panel 1 (e.g., a 45 degree angle, as shown in FIG. 1). The pivotal coupling may be detachable such that the display surface 2 can be removed for safe storage during transportation of the device. Alternatively, the display surface 2 is detachably coupled to one side of the display panel 1 via an integrated or detachable slot 4 that runs along a side of the display panel 1 such that the display surface 2 is inserted into the slot 4 at a 45 degree angle relative to the display panel. The display surface 2 is at least the same size (e.g., length and width) of the display pane 1. In certain embodiments, the dimensions of the display surface 2 are slightly larger (e.g., longer and/or wider) than the display panel 1.

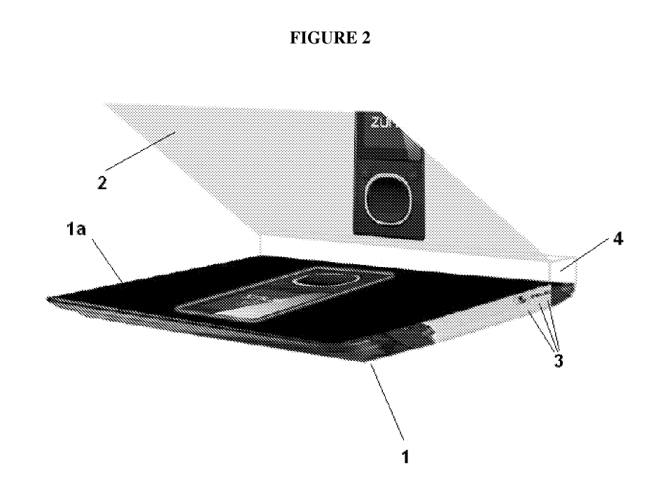

In operation, the display surface 2 is opened or mounted at a substantially 45 degree angle extending from the bottom of the viewable image display area of the display panel 1 positioned at a distance, preferably farthest, from the spectator or viewer V (see FIG. 1) and would span the entire height of the viewing screen of the display panel 1 (see FIG. 1 or FIG. 2). The display surface 2 would reach the footprint of the panel 1 when viewed from the top down. In a particular embodiment, display surface 2 contains an anti-reflective coating to produce a high degree of reflectivity on the side facing the screen 1a of the display panel 1, and a high degree of translucency on the opposite side of the display surface 2. Such setup will prevent ghosting of the image reflected on the display surface 2.

When the display surface 2 is positioned at a 45 degree angle relative to the display panel 1, as shown in FIG. 1 or FIG. 2, the reflective or partially reflective display surface 2 reflects and/or refracts the image displayed on screen 1a of the display panel 1 such that the image appears to the spectator or viewer as if it is floating or hovering (i.e., a hologram) above the display screen 1a of the panel 1, or in front of the visual display system, when viewed from the front (i.e., viewing into the angle A) of the device. While the holographic image can be perceived by a viewer/spectator from any distance from the device, the viewing angle of the holographic image is between 110 to 170 degrees, preferably 115 to 160 degrees, even more preferably 120 to 150 degrees from a single point in the center of the display surface (or any specific value within said ranges). The size of the hologram is confined to the boundaries defining the display screen 1a of the display panel 1.

In the embodiments, where an anti-reflective coating is used on the display surface, the holographic image is only perceived from the front (i.e., viewed into angle A) of the device. Where no anti-reflective coating is used, the holographic image is perceived from both the front side and the back side of the display surface/visual display device. If the display surface is positioned at an angle less than or greater than 45 degrees relative to the display panel, the spectator or viewer V does not perceive any holographic image, and instead sees through the translucent display surface 2, from both the front and back sides of the display surface/device, regardless of whether an anti-reflective coating is used.

Preferably, the device should be placed in such a way that the surface or screen 1a of the display panel 1 is out of the view of the spectator. That is, the surface of the display panel 1 should be generally at eyelevel of the spectator or viewer of the unit.

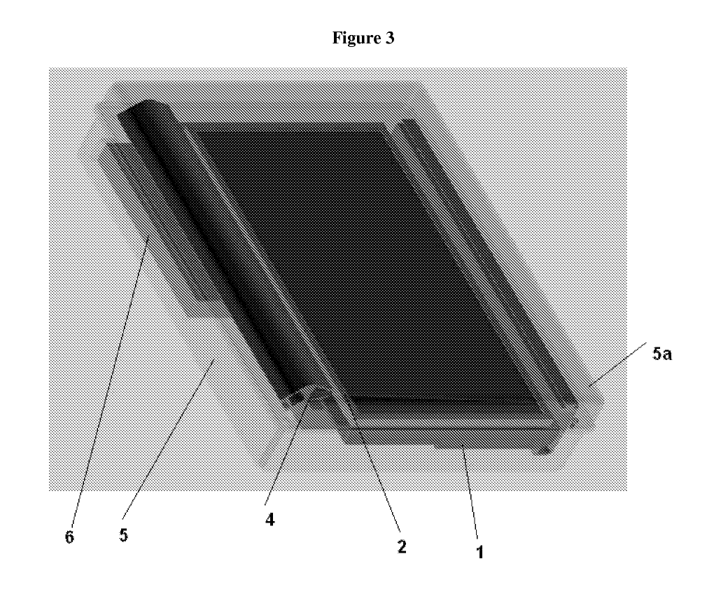

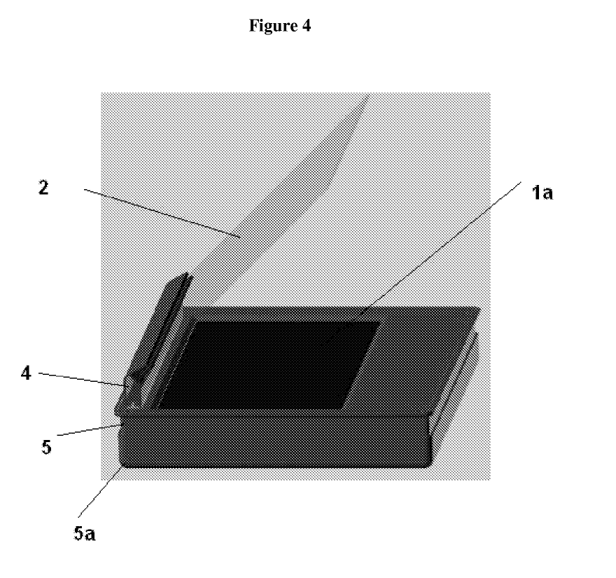

In certain embodiments, the invention further includes a dual action case 5 for transport and assembly, as shown in FIG. 3. Preferably, the case 5 is configured for retail shelf mounting and/or hanging from a ceiling. The display panel 1 and/or display surface 2 can be placed within the portable case unit 5, which acts as a protective travel case during shipping/transportation and storage. The case unit 5 can include one or more compartments for housing the display panel 1 and/or display surface 2. For example, the case unit 5 includes a main compartment or base for housing or mounting the display panel 1, and the lid 5a of the case unit 5 may include an internal sleeve for containing the reflective display surface 2. The main compartment or base can be configured to further house/mount the player unit 6 and/or power supply for the display panel 2. The lid 5a of the case unit 5 may be detachable and placed under the unit 5 so that it serves as a cradle for the unit (see FIG. 4).

In certain embodiments, the display panel 1 is mounted in the base of the case 5 on its back parallel to the major plane of the unit. The player unit 6 and the power supply for both the display panel 1 and player unit 6 are mounted within underneath the display panel 1. In operation, and when the lid 5a of case 5 is opened, the display surface 2 is opened or mounted at a substantially 45 degree angle extending from the bottom of the screen 1a of the display panel 1 positioned a distance, preferably farthest, from the spectator or viewer and would span the entire height of the screen 1a of the display panel 1. The display surface 2 would reaches the footprint of the case 5 when viewed from the top down. Preferably, the case unit 5 should be placed in such a way that the surface or screen 1a of the display panel 1 is out of the view of the spectator. That is, the surface of the display panel 1 should be generally at eyelevel of the spectator or viewer of the unit.

The device of the invention can play or disclose any content that can be configured in electronic means. Preferably, in order to provide for an optimal image, the content should be created with a highly pixilated image such as high definition. Moreover, for the best imagery, the content should be “cut out” or traced content such that the content should not be inputted as full frame or break frame due to image size and viewing constraints.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A visual display system comprising:
a horizontal panel comprising a top surface and a bottom surface and a display screen disposed on the top surface, the panel configured for displaying an illuminated reference image on said display screen; and
a reflective or partially reflective surface removably coupled to a side of said panel and disposed over said display screen at an angle sufficient for receiving and reflecting at least a portion of the illuminated reference image to produce a reflected image.

2. The visual display system of claim 1, wherein said reflective or partially reflective surface is disposed at a 45 degree angle relative to said display screen.

3. The visual display system of claim 1, wherein the display screen of said panel comprises a brightness ranging from 500 to 1,000 nits.

4. The visual display system of claim 1, wherein at least one side of said reflective or partially reflective surface contains an anti-reflective coating.

5. The visual display system of claim 1, wherein said reflective or partially reflective surface comprises a beam splitter device selected from a dielectric mirror, a dichroic mirror, an interferometer, teleprompter mirror, a half-silvered mirror, or a beam splitter cube.

6. The visual display system of claim 1, wherein said panel comprises an LCD panel or an LED panel.

7. The visual display system of claim 1, wherein the reflected image is perceivable to a viewer at an angle ranging between 120 to 150 degrees relative to a center point of said reflective or partially reflective surface.

8. The visual display system of claim 1, further comprising a player unit operably coupled to said panel for displaying an image on said display screen of said panel.

9. The visual display system of claim 8, wherein said player unit is an integrated component of said panel.

10. The visual display system of claim 8, wherein said player unit is an IP addressable or Wi-Fi capable unit.

11. The visual display system of claim 8, wherein said player unit comprises a high definition (HD), video graphics array (VGA) or digital visual interference (DVI) output.

12. The visual display system of claim 1, further comprising a protective case for transporting said visual display system comprising:
a base unit having an interior cavity configured for securely housing at least the panel; and
a detachable lid comprising an internal sleeve for housing the reflective display surface.

13. A portable visual display system comprising:
a horizontal panel comprising a top surface and a bottom surface and a display screen disposed on the top surface, the panel configured for displaying an illuminated reference image on said display screen;
a reflective or partially reflective surface removably coupled to a side of said panel and disposed over said display screen at an angle sufficient for receiving and reflecting at least a portion of the illuminated reference image to produce a reflected image; and
a protective case for transporting said visual display system a base unit having an interior cavity configured for securely housing at least the panel, and a detachable lid comprising an internal sleeve for housing the reflective display surface.

14. The visual display system of claim 12, wherein said reflective or partially reflective surface is disposed at a 45 degree angle relative to said display screen.

15. The visual display system of claim 12, wherein the display screen of said panel comprises a brightness ranging from 500 to 1,000 nits.

16. The visual display system of claim 12, wherein said reflective or partially reflective surface comprises a beam splitter device selected from a dielectric mirror, a dichroic mirror, an interferometer, teleprompter mirror, a half-silvered mirror, or a beam splitter cube.

17. The visual display system of claim 12, wherein said panel comprises an LCD panel or an LED panel.

18. The visual display system of claim 12, wherein the reflected image is perceivable to a viewer at an angle ranging between 120 to 150 degrees relative to a center point of said reflective or partially reflective surface.

19. The visual display system of claim 12, further comprising a player unit operably coupled to said panel for displaying an image on said display screen of said panel.

20. The visual display system of claim 19, wherein said player unit is an integrated component of said panel.
